(19) United States
(12) Patent Application Publication
(10) Pub. No.: US 2015/0373040 A1
(43) Pub. Date: Dec. 24, 2015

(54) SHARING INFORMATION

(71) Applicant: HEWLETT-PACKARD DEVELOPMENT COMPANY, L.P., Houston, TX (US)

(72) Inventors: Tomas Sander, Princeton, NJ (US); William G. Horne, Princeton, NJ (US); Prasad V. Rao, Princeton, NJ (US); Suranjan Pramanik, Sunnyvale, CA (US); Siva Raj Rajagopalan, Chandler, AZ (US); Daniel L. Moor, Midland, MI (US); Krishnamurthy Viswanathan, Palo Alto, CA (US)

(21) Appl. No.: 14/764,596

(22) PCT Filed: Jan. 31, 2013
(86) PCT No.: PCT/US2013/024067

§ 371 Date: Jul. 30, 2015

(51) Int. Cl. H04L 29/06

(52) U.S. Cl. CPC H04L 63/1425; H04L 63/1433; H04L 63/1441

(57) ABSTRACT

Sharing information can include identifying, utilizing a threat exchange server, a security occurrence associated with a participant within a threat exchange community. Sharing information can also include determining what participant-related information to share with the threat exchange server in response to the identified security occurrence, and receiving, at the threat exchange server, information associated with the determined participant-related information via communication links within the threat exchange community.

### BACKGROUND

Entities maintain internal networks with a number of connections to the Internet. Internal networks can include a plurality of resources connected by communication links and can be used to connect people, provide services, and/or organize information, among other activities associated with an entity. Due to the distributed nature of the network, resources on the network can be susceptible to security attacks. A security attack can include, for example, an attempt to destroy, modify, disable, steal, and/or gain unauthorized access to use of an asset (e.g., a resource, confidential information).

### BRIEF DESCRIPTION OF THE DRAWINGS

FIG. 1 illustrates an example of an environment for sharing information according to the present disclosure.

FIG. 2 illustrates a block diagram of an example of a method for sharing information according to the present disclosure.

FIG. 3 illustrates a block diagram of an example of a method for sharing information according to the present disclosure.

FIG. 4 illustrates a block diagram of an example of a system according to the present disclosure.

### DETAILED DESCRIPTION

Information (e.g., data) confidentiality can be a concern for entities that participate in an exchange of threat and security related information. A decision whether information should be shared or not may depend on static properties of the information, such as, for example, whether the information contains Personally Identifiable Information (PII). The decision may also depend on a changing threat exchange community (or environment) and security context in which information is being shared. For example, when a security context (e.g., an overall threat level) in the threat exchange community indicates that a security risk has increased (e.g., an increase in the overall threat level) or that a piece of information may help a particular security investigation important to an entity, the entity may be willing to share information that it otherwise wouldn't.

A threat exchange community is a group of computing systems that exchange information related to information technology infrastructures (e.g., systems and services) via communications links. The computing systems can be referred to as participants of the threat exchange community. In some implementations, entities including or controlling the computing systems can also be referred to as participants of the threat exchange community.

As an example, a threat exchange community can include a participant server or group of participant servers within the information technology infrastructure of each entity from a group of entities. Each participant server (or each group of participant servers) provides information related to actions within and/or at the information technology infrastructure including that participant server to a threat exchange server. A threat exchange server, as used herein, can include computer hardware components (e.g., a physical server, processing resource, memory resource, etc.) and/or computer-readable instruction components designed and/or designated to provide a number of threat exchange functions. The threat exchange server analyzes the information provided by each participant server to identify security occurrences within the threat exchange community, and provides alerts related to the security occurrences to participant servers, as will be discussed further herein.

In some implementations, participant servers communicate in a peer-to-peer architecture and the threat exchange server (or functionalities thereof) is distributed across the participant servers or a subset of the participant servers. That is, in some implementations a threat exchange community does not include a centralized threat exchange server. Rather, the threat exchange server is realized at a group of participant servers.

In a number of examples of the present disclosure, an automated threat exchange server within a threat exchange community can be used to provide filtering and protection for shared information. The threat exchange server can monitor and communicate with participants (e.g., entities) within the threat exchange community to make sure they neither over- nor under-share information, and that the threat exchange server receives as much information as possible to address needs of a particular threat exchange community in a particular security context (e.g. overall threat level, new attack found, etc.) without violating confidentiality policies and/or needs of the participants.

External variables influencing the security context, such as a general threat level of the community, can be the same for all (or subgroups) of the participants in the community, and this can allow for implementation of comparable sharing activities among the participants. For example, in view of a security context that indicates an increased alert state, all participants may share sensitive information related to an incident that they normally would not, a decision that may help resolve the increased alert state within the community. This can also help enforce that every community participant contributes a fair share of information when necessary and warranted by publicly verifiable conditions. This can reduce “free-riders.” A free-rider exists when a participant only wants to get information out of the threat exchange community, but is unwilling to input information.

Prior approaches to sharing information may not consider the context in which the information is shared (e.g., the security context). In contrast, examples of the present disclosure allow participants in a threat exchange community to use information related to a present security context (e.g., a security or attack threat level) to determine how much and/or which security-related information to share with the threat exchange server and/or with other participants of the threat exchange community.

In a number of examples, systems, methods, and computer-readable and executable instructions are provided for sharing information. Sharing information can include identifying, utilizing a threat exchange server, a security occurrence associated with a participant within a threat exchange community. The security occurrence is evidence of a current security context within the threat exchange community. For example, the existence of or a change in a security occurrence can indicate that the security context for a participant specifically or the threat exchange community generally has changed. In other words, the security occurrence can be used to determine a security context within the threat exchange community. As a specific example, identification of a new security occurrence can indicate that a security threat level has increased at the participant or within the threat exchange community.

Sharing information can also include determining what participant-related information to share with the threat exchange server in response to the identified security occurrence, and receiving, at the threat exchange server, information associated with the determined participant-related information via communication links within the threat exchange community. Said differently, the participant-related information to be shared with the threat exchange server can be determined based on a security context (e.g., a security threat level) evidenced by the security occurrence.

In the following detailed description of the present disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the present disclosure.

As used herein, “a” or “a number of” something can refer to one or more such things. For example, “a number of participants” can refer to one or more participants.

External sharing of security and threat related information about an information technology (IT) system can expose the sharing participant to significant risks, including a reputational risk, a security risk (e.g., if the sharing discloses weaknesses that attackers might use against it), liability risks (e.g., if a third party is wrongly implicated as bad actor), and/or a legal compliance risk (e.g. if PII is shared where it shouldn't).

Sharing information with a threat exchange server or community can be beneficial to a participant and can depend, for example, on an importance of a piece of information, for example, to complete an analysis of a serious security attack that a number of participants of the threat exchange community are currently under. In a number of examples, a participant can determine that sharing a particular piece of information with a threat exchange server and/or other participants may have benefits that outweigh risks. In some examples, these benefits and risks can depend on dynamically evolving context in which the information is being shared (e.g., a general threat exchange community threat level). A challenge can be to determine an optimal point between benefits and risks, or alternately increasing the efficiency of the information sharing by sharing the right amount between participants determined by the context.

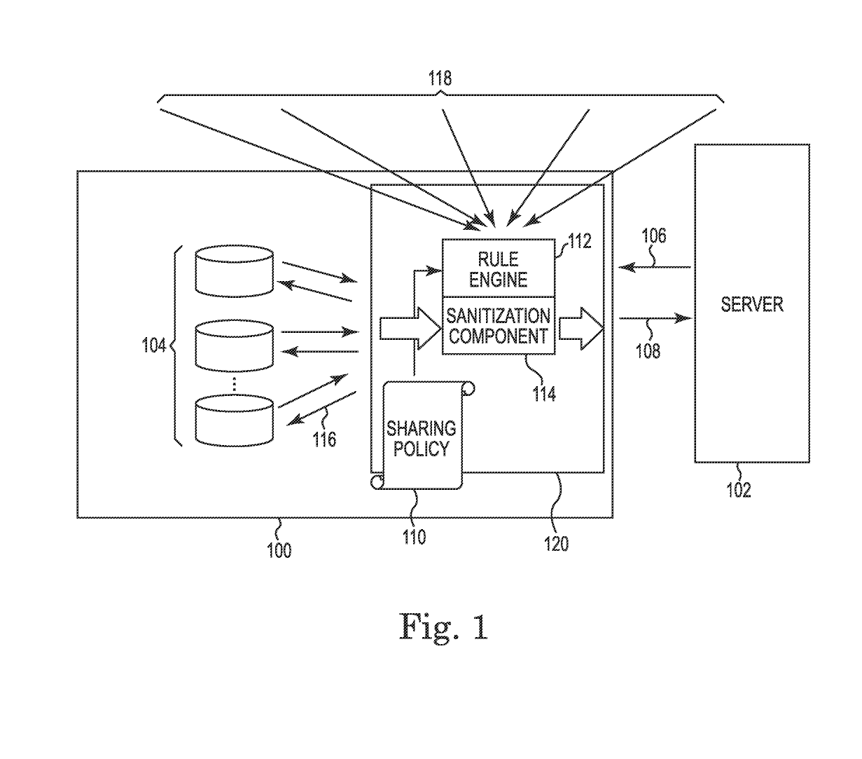

FIG. 1 illustrates an example of an environment 100 for sharing information according to the present disclosure. Environment (e.g., IT environment) 100 can include a participant (e.g., entity) within a threat exchange community, a participant portion 120 of the threat exchange community, and a number of databases 104. Databases 104 can include security- and participant-related information and content. Participant information can include, for example, IT system information, industry sector information, and/or infrastructure information (e.g., hardware, application names, versions, patch levels, etc.) among other data related to a participant. Security information can include, for example, attacker information, attack-type information, known vulnerabilities exploited, incident information, patterns, rules, and remediation, suspicious files, and log information, among others.

This raw, unfiltered information can be shared with participant portion 120 via communication links 116, for example. Communication links, as used herein, can include network connections, such as logical and/or physical connections. The communication links (e.g., links 116, 106, 108) providing communication from a database to a participant and/or from a participant to a threat exchange server 102 may be the same and/or different from the communication links providing communication from the participant to the database and/or from the threat exchange server 102 to the participant (e.g., participant portion 120), for example.

The participant can be one of a number of participants in a threat exchange community and can include a participant portion 120 of the threat exchange community. Portion 120 can be a portion of a participant's entity (e.g., an information technology portion) that participates in the threat exchange community to identify security threats. For instance, a threat exchange community can include a plurality of entities connected by a threat exchange server (e.g., server 102), wherein each entity is a participant within the threat exchange community. Each participant can provide security information (e.g., IP address information, PII, participant-specific security information, etc.) to the threat exchange server via communication links. The participant-provided security information can be used to share information to reduce security risk for individual participants, the entire community, and/or sub-groups of the community. In the example illustrated in FIG. 1, the participant (e.g., the participant portion 120) can communicate with threat exchange server 102 via communication links 106 and 108.

A number of parameters 118 including, for example, metadata of security events, a security threat level associated with a query, the identity of a participant issuing the query, the information that is requested, the information that has previously been provided by a participant, whether the host has detected a security threat, a threat/security event provided by a threat exchange server, etc. can be used to identify a security occurrence (e.g., a type or level of security threat to a participant, a current state of a participant's security context, etc.) affecting the participant. In a number of embodiments, security occurrences are variables and information (e.g., data) that influence an action by the threat exchange server. For example, such security occurrences that influence an action can include, for example, information describing a security context, security attacks, security threats, suspicious events, vulnerabilities, exploits, alerts, incidents, and/or other relevant events, identified using the participant-provided information.

A vulnerability is a flaw or weakness in a system's design, implementation, or operation and management that could be exploited to violate the system's security policy. An exploit is a sequence of commands (e.g., a piece of software, a chunk of data, etc) that takes advantage of a vulnerability in order to cause unintended or unanticipated behavior. For example, an exploit must take advantage of a vulnerability, and a vulnerability that cannot be exploited is not vulnerable.

An attack (or security attack) is the attempted use of one or more exploits against one or more vulnerabilities. An attack can be successful or unsuccessful. The victim may not realize he or she has been attacked until after the fact. For example, a forensic investigation may have to be performed to determine what exploits were used against what vulnerabilities during an attack. Vulnerabilities, exploits, and attacks may be known or unknown to some group of people, either because they have not been discovered or because they are being kept secret. For example, it is entirely possible there are vulnerabilities that will never be discovered; a hacker may have constructed an exploit, but keeps it secret, so that they are the only person who knows of its existence; an attack may be kept secret by the victim for fear of harm to their brand; etc.

A threat (or security threat) is information that indicates the possibility of an impending attack. There may be a plurality of types of information that can indicate a possible attack. For example, such information can include the knowledge of a vulnerability or exploit, with the assumption that if they exist, then they will be used. Information that an attack has occurred in organization A raises the possibility that the same attack might be directed organization B.

An event (or security event) is a description of something that happened. An event may be used to describe both the thing that happened and the description of the thing that happened. Examples of events include, “Alice logged into the machine at IP address 10.1.1.1”, “The machine at IP address 192.168.10.1 transferred 4.2 gigabytes of data to the machine at IP address 8.1.34.2.”, “A mail message was sent from fred@flinstones.com to betty@rubble.com at 2:38 pm”, or “John Smith used his badge to open door 5 in building 3 at 8:30 pm”. Events can contain a plurality of detailed data and may be formatted in a way that is machine readable (e.g. comma separated fields). In some examples, events do not correspond to anything obviously related to security. For instance, events can be benign.

An alert (or security alert) is kind of event that indicates the possibility of an attack. For example, intrusion detection systems look for behaviors that are known to be suspicious and generate an event to that effect. Such an event may have a priority associated with it to indicate how likely it is to be an attack, or how dangerous the observed behavior was.

An incident (or security incident) is information that indicates the possibility that an attack has occurred or is currently occurring. Unlike a threat, which is about the future, an incident is about the past and present. An incident can include evidence of foul play, an alert triggered by a system that detects exploit activity, or suspicious or anomalous activity. Incidents may be investigated to determine if an attack actually did happen (in many cases an incident can be a false positive) and what were the root causes (i.e. what vulnerabilities and exploits were used).

Context (or a security context) is information that describes something about the participants (e.g. the type of organization, the type of infrastructure they have, etc.), something about an individual or local threat environment, and/or something about the global threat environment (e.g. increased activity of a certain type), for example. Said differently, a security context describes or is the security-related conditions within the threat exchange community. As examples, a security context can describe or account for a security threat level within the threat exchange community, a qualitative assessment of the security attacks or security threats within the threat exchange community, activity or events within the threat exchange community, the IT infrastructure within the threat exchange community, incidents within the threat exchange community, information provided by a threat exchange server, information collected by a participant of the threat exchange community, and/or other security-related information. As a specific example, a security context can be defined by security occurrences within a threat exchange community. That is, the security context of a participant or the threat exchange community can be determined based on security occurrences identified within the threat exchange community.

Parameters 118 can also include or describe, for example, a general community threat level (e.g., critical, high, medium, low), external threat intelligence (e.g., external analyst-provided information), a criticality of a query to a participant from the threat exchange server, and an urgency of a participant's query for information from the threat exchange server. Such information can be useful to identifying a security occurrence within a threat exchange community. Parameters 118 can, in a number of embodiments, include or represent information described by a number of indicators. Such indicators can include, for example, “security” parameters (e.g., information associated with security of the threat exchange community or its individual participants), “internal” parameters (e.g., information gained from within the threat exchange community), and “external” parameters (e.g., information gained from within the threat exchange community), among others.

A sharing history of a participant can also be a parameter considered. For example, a participant may have a history of sharing information with particular participants in a threat exchange community, but not with others. Additionally, a participant may have a history of sharing information only if the participant determines the security occurrence to be critical, for example.

The security occurrence (e.g., from which a participant's current security context can be determined) can be a parameter to participant policies (e.g., rules) and/or it can be used to select a particular set of rules that are applied to a query for security-related information. For example, a participant may have a sharing policy 110 that indicates that more information can be shared with the threat exchange server 102 if the security occurrence indicates an increased (e.g., significant) security threat, but less will be shared if the security occurrence indicates that there is little or no significant security threat. For example, if a security context and/or overall threat level is “low” as compared to “high”, “elevated”, etc. the participant may choose not to share information with the threat exchange server and/or other participants.

A number of the values (e.g., a threat level) of the parameters 118 can be derived automatically, and a number of values can be provided via manual input by the security administrator of the sharing organization. Threat exchange server 102 can make occasional, periodic, and/or continuous queries to a participant via communication link 106, for example, to request information it needs in an investigation of attacks (e.g., and ongoing investigation). For example, such queries can be made in response to identification of security occurrences. A criticality and urgency of such queries made by threat exchange server 102 can be expressed as part of the query and can be automatically taken into account for how to respond to the query at the participant side.

For example, the criticality and/or the urgency of such queries can be used (e.g., by a participant) to determine that the current security context has an increased or high (e.g., queries are more critical or urgent) security threat level or a decreased or low (e.g., queries are less critical or urgent). If the current security context has an increased security threat level, more information or information at a finer granularity can be provided in response to the query. If the current security context has a decreased security threat level, less information or information at a coarser granularity can be provided in response to the query.

In other words, information such as the overall community threat level can be learned by threat exchange server 102 and/or a participant automatically based on security occurrences, and can be used to determine a security context at threat exchange server 102 or at a participant of a threat exchange community. When deciding whether to share information about an incident at a threat exchange participant, an analyst (e.g., a security analyst) can also manually provide input (e.g., external information) to influence or affect the determined security context, such as a rating of how important it is for his or her organization to learn about related information from the threat exchange server. Automatically learned information can be considered in conjunction with the external information as a security context when determining information needed to address a security occurrence.

To address the dynamic and conditional nature of sharing information utilizing external and/or internal parameters 118, the parameters 118 can include individual and/or group expiration dates. In some examples, threat exchange server 102 may agree to delete information when it expires.

A mechanism to determine a security occurrence based on parameters 118 can, for example, be implemented by a rules engine 112 whose rules reflect the sharing policy 110 and confidentiality needs of the threat exchange participant, as well as in some instances those of the threat exchange server 102 and those agreed upon by the threat exchange community. Rule engine 112 makes use of two components: a security information sharing policy (SISP) 110 (e.g., specified using the syntax of the JBoss rules language), and locally available security parameters 118. The rule engine 112 applies the SISP 110 to a security occurrence determined from the security parameters 118 in order to determine the amount of sharing to be done on the information in question. In order to do this, the rule engine 112 can handle the presence of negation in conditions and a prioritization of rules in order to analyze a number of conflicting results in response to the same situation.

A participant can utilize a sanitization component 114 within portion 120 to sanitize (e.g., filter) information (e.g., unfiltered information from databases 104) to be communicated to threat exchange server 102. For example, information that the participant deems sensitive and non-sharable can be removed before sharing, and the filtered information can be shared with threat exchange server 102 via communication link 108.

In a number of examples, the information sanitized can vary according to security context in a policy-driven manner. For example, sanitization component 114 may not remove sensitive information (e.g., data) during times when a threat level is increased. In addition, during periods of an increased threat level, sanitization component 114 may not replace sensitive information with more generalized data, as it may if the threat level is decreased.

Sanitization component 114 can, for example, be influenced by (e.g., depend on) rule engine 112, sharing policy 110, and parameters 118 (or a security occurrence identified from parameters 118). For example, these components can influence what information is sanitized by component 114, and what information is sent as raw, unfiltered information.

Dynamic sharing of information (e.g., a capability to dynamically share and adjust information) utilizing threat exchange server 102 can prevent over-sharing or under-sharing of information by threat exchange participants. Under-sharing can disadvantage a threat exchange community, as a threat exchange server may not learn as much information as it should to perform analytics on security threats. Over-sharing may disadvantage a sharing participant, as the participant may take on an increased risk, and it may be difficult to extract useful information if a receiving party (e.g., another threat exchange participant, threat exchange server 102) is flooded with unnecessary information.

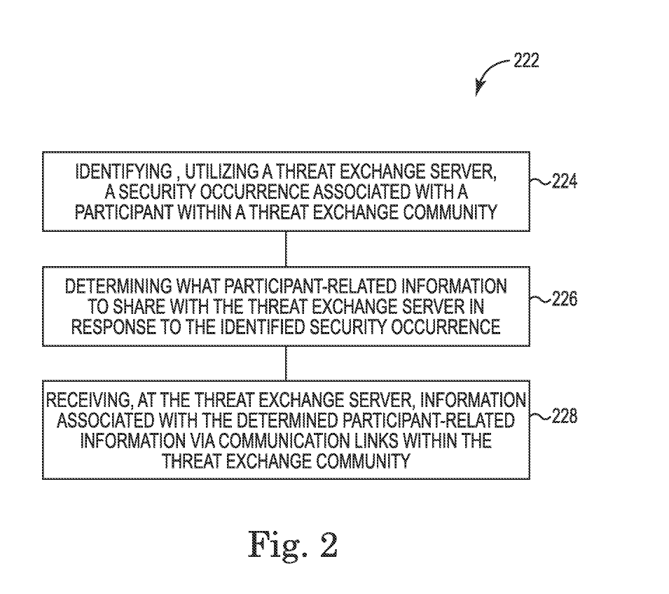

FIG. 2 illustrates a block diagram of an example of a method 222 for sharing information according to the present disclosure. Dynamically sharing information within a threat exchange community can allow participants to share information that is less sensitive when a security threat is low, and share more information (e.g., to improve the ability of the threat exchange server to determine whether other participants are experiencing a threat or to suggest a mitigation strategy for a threat) when the security threat is high.

At 224, a security occurrence associated with a participant within a threat exchange community is identified utilizing a threat exchange server. The threat exchange server can identify a number of security occurrences associated with the individual participant (e.g., a phishing scam targeting a particular entity) and/or the threat exchange server can identify a number of security occurrences associated with the entire threat exchange community (e.g., an increased global threat level) or a subgroup of the threat exchange community (e.g., malware aimed at a particular type of entity, such as banks).

At 226, a determination of what participant-related information to share with the threat exchange server is made in response to the identified security occurrence. The threat exchange server may determine that the security occurrence provides a decreased risk to a participant or participants, and request little or no information from participants. Conversely, the threat exchange server may determine that a number of participants are at an increased risk due to the security occurrence (e.g., a security threat), and may request sensitive information from a participant or participants. Additionally, the threat exchange server can consider a number of parameters (e.g., a participant's sharing history) when determining what information to request from participants.

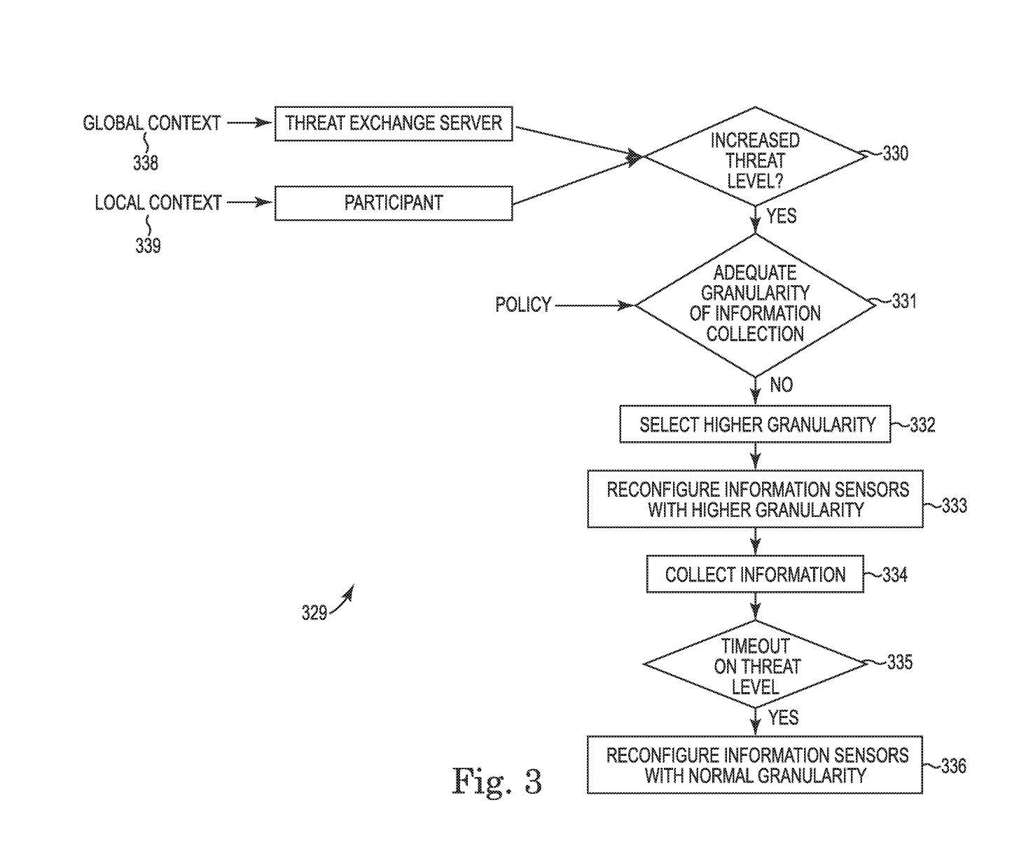

In a number of embodiments, as will be discussed further herein with respect to FIG. 3, a threat exchange server may determine the granularity with which the information is shared is insufficient to address the security occurrence. In some examples, the threat exchange server may request additional information (e.g., information at a finer granularity) from a participant or participants until sufficient information is available.

Information associated with the determined participant-related information (e.g., an IP address needed to mitigate a threat) is received by the threat exchange server via communication links within the threat exchange community at 228. The threat exchange server may request particular information from a number of participants according to the determination made about the security occurrence. After receiving the request a participant may choose to share the requested information or information associated with the requested information with the server and/or other participants in the threat exchange community. This decision can be based on, for example, an information sharing policy of the participant.

In a number of embodiments, the threat exchange server can utilized the information received by the participant to help the participant deal with a security occurrence. The threat exchange server can suggest a security occurrence mitigation strategy to the participant based on the security occurrence and the received information. For example, the threat exchange server may have dealt with the occurrence previously and/or may have received similar information from another participant within the threat exchange community. Based on the information received from the participant, the threat exchange server can suggest a strategy to prevent or reduce negative effects of the security occurrence.

Threat exchange participants can share information with the threat exchange server occasionally, periodically, or continuously. However, sharing with a threat exchange server every piece of security information held by a participant at once can bog down the threat exchange server and the threat exchange community. Logging all of the information from the beginning may not feasible because of time and space constraints.

A threat exchange server can determine additional information to be collected from a threat exchange community participant. A dynamic approach can be utilized, where a current security occurrence (e.g., which evidences a security context that describes a current security threat level) and other details available at the threat exchange server are used to decide which additional information is required for further security occurrence analysis (e.g., security threat and/or incident analysis). In a number of embodiments, the threat exchange server can determine the additional information required and request it from the participants. For example, event information such as records within a log or an alert raised by an intrusion detection system can be used by the threat exchange server to determine additional information and/or can be additional information requested by the threat exchange server. The participants can receive the request from the threat exchange server, gather the information, and upload the information to the threat exchange server. To determine the additional information, a threat exchange server and threat exchange participants can be updated by sharing information via information tables, as will be discussed further herein.

Threat exchange participants can upload an amount of information determined by a threat exchange server to be required for global analysis at the threat exchange server, by starting with an initial set of default (e.g., “basic”) information that can be shared and increased as needed. In some instances, for example in situations where a global community threat level is increased, participants can share more information than is normally necessary, and dynamically scale back the amount of information shared as the threat subsides.

As noted above, in a number of examples, a threat exchange server may suggest and/or request additional information based on a noticeable or identified security occurrence or in response to a query for which it does not have all the information it needs. In some instances, participant confidentiality policies may be in place at the participant side to prevent sensitive information leaking when additional information is selected for sharing. Additionally or alternatively, the threat exchange server may recognize that particular information being shared from some participants is benign, and in response, the threat exchange server can notify the participants that they can stop sharing that information.

Threat exchange participants can, for example, use similar indicators from the threat exchange server to log and/or upload additional information to the threat exchange server. In some instances, a first participant may respond with more information than a second participant for the same query. For example, the first participant may have a more generous initial sharing policy than the second, so the threat exchange server may already have more information from the first participant as compared to the second.

As noted above, the threat exchange server can determine who and what to query for, based on lookup tables and a current security occurrence (which evidences a security context that describes a current security threat level) at the server. Threat exchange participants can be configured with a set of tables to be shared with the threat exchange server. These tables can comply with confidentiality policies set at the participants. Based on the interaction between participants and the threat exchange server, additional information can be shared between participants and the threat exchange server. Additional information to be shared can be determined automatically. In some examples, participants can manually override some of these decisions or add extra information on their own.

The information can be shared in a number of ways. For example, a table with multiple fields (e.g., strings, integers, floating point numbers, and Internet protocol (IP) addresses, among others) can be used to share the information. The fields can be a subset of security occurrence fields (e.g., security event/incident fields), which can be used to represent logs from various security devices such as firewalls, antivirus, internet provider security, and intrusion detection systems, among others. A threat exchange participant can decide fields for which it will provide values in the clear (e.g., without pseudonymizing the information), for which fields it will pseudonymize the values (e.g., not traceable back to the participant), and for which fields it will provide no values. Based on the threat-level at the threat exchange server, a participant can share more values or leave more information in the open, for example.

In some examples, the fields required to describe a security occurrence (e.g., a security event indicating a security threat or security attack) are not known at the beginning. In such a situation, extra tables can be created when security occurrences are discovered to share more information regarding the security occurrence.

Historical information may be analyzed for use in threat exchange. The threat exchange server may not have all the information required to detect a security occurrence (e.g., a security compromise). In response to such a situation, additional resources such as trends, queries, and filters can be sent to the participant. These resources can query a participant and/or threat exchange server database for additional historical information related to the participant (e.g., past responses in similar situations) and generate statistics and/or signatures. The new statistics and/or signatures can be shared with the threat exchange server, so that they can be analyzed. The additional resources can be shared within the threat exchange community.

In a number of embodiments, patterns can be used to share threats between participants and a threat exchange server in a threat exchange community. A pattern can include a sequence of activity that happens a number of times (e.g., frequently) and/or a particular behavior between a number of participants (e.g., participant A regularly shares information X with Participant B in situation Y). Some of these patterns can contain information that is helpful, for example, in defending against or predicting a security occurrence (e.g., defending against and/or predicting a security threat). This information can include sensitive information that the participants may not share with the threat exchange server. A participant can query the threat exchange server to check if other participants have seen similar patterns. If similar patterns exist at the threat exchange server, the participant can decide whether to upload related patterns, so that a resolution can be reached for the patterns.

In some examples, information from security devices (e.g., firewalls, antivirus, active directory, IDS, etc.) can be sent to threat exchange participants (e.g., via communication links). The threat exchange server can determine if the information from a certain security device is necessary for analyzing a threat, and request the participants to start the connector and receive information from the security device.

Participants can capture and share information based on threats that are being investigated. For example, consider two participants, Participant A and Participant B both running the same web server. Participant A monitors the network traffic and does not have capability of monitoring the web server. Participant B has the capability of monitoring the web server, but does not have capability of monitoring the network traffic, Participant A shares the network statistic with the threat exchange server. The threat exchange server sees a spike in the web traffic and requests Participant B to monitor the web server logs. Participant B monitors the web server logs and either analyzes them itself or decides to share them with the threat exchange server. While analyzing the web server logs, a vulnerability is discovered, and that vulnerability is shared with both participants. Thus, Participant B does not have to monitor (or share) the web server logs all the time but only when a potential abnormality is detected.

Threat exchange participants may have to produce long running reports and pattern discoveries at periodic intervals for threat monitoring and compliance regulations. Different participants may run these scheduled jobs at different times of the day or week and upload the results to the threat exchange server. Participants can query the threat exchange server and based on the response, prioritize the scheduled jobs so that they get immediate knowledge of imminent threats or abnormalities.

In a number of examples, method 222 can be performed iteratively. For example, security occurrences can be identified continuously, at the same time as determinations about what participant-related information to share are made dynamically. Similarly, information can be shared dynamically, at the same time as security occurrences are being identified and determinations about how much information to share are being made.

FIG. 3 illustrates a block diagram of an example of a method 329 for sharing information according to the present disclosure. Participants in a threat exchange community can dynamically vary a granularity (e.g., level of detail) and other related aspects of threat monitoring and sharing according to a current (e.g., present) security occurrence so as to control and dovetail costs of monitoring the security occurrence and/or threat posed by the security occurrence. For example, a current security occurrence can include a changed security and/or attack threat level or knowledge of a specific suspected attack model.

Specification of what information to collect, filter, store, and share by a participant and/or threat exchange server may be ad hoc and/or uneven. Information collected by a threat exchange server may not be at an adequate level of detail to be useful in detecting a presence of a particular suspected security occurrence, (e.g., attack or threat). As a result, security occurrences may go undetected even though the information to detect the security occurrence is considered to be available but generally not collected.

For example, an adequate level of detail may be much higher than what is collected by default settings in the threat exchange server, putting strain on performance, network, and/or storage resources; therefore, there may be resistance from participants and/or the threat exchange server to collect fine-grained information without justification. Even if information is collected at fine grain, participants may choose to share only aggregates with the threat exchange server for fear of being profiled by an adversary. In a number of embodiments, method 329 can include collecting and/or sharing information only at a level of detail that is necessary for threat detection at a given moment or time window, by dynamically increasing the granularity when a system is under threat and gradually easing back to lower levels when threats subside.

Method 329 can include the threat exchange server requesting modulated and/or varied levels of granularity (e.g., in terms of information precision, periodicity of collection, aggregation level, etc.) of monitored and collected information related to a present security occurrence (e.g., a suspected attack or change in security threat level) from participants. Additionally or alternatively, participants can modulate or vary a level of granularity of monitored and collected information related to the present security occurrence to determine how much and/or which security-related information to collect and share with the threat exchange server (or with other participants of the threat exchange). For instance, higher suspicion of a threat or active attack can lead to automatic collection of finer-grained information, which can gradually ease to reduced levels (e.g., default or “normal” levels) when the security occurrence is considered to be contained.

A number of global parameters (e.g., an overall threat level set by the threat exchange server) and local parameters such as detection of attack precursors in a participant's environment (e.g., set by each participant) can be defined by a threat exchange server and/or participants at 338 and 339 to identify a security occurrence. For example, the overall threat level may indicate that a new undefined worm may be raging on the Internet (i.e., a security occurrence) which may warrant increased monitoring at firewalls and other critical servers, whereas suspicion that a particular participant is being targeted in a phishing attack (i.e., a security occurrence) may warrant increasing monitoring of email and web access patterns just for that participant.

The parameters, such as an overall threat level or detected potential threat can depend on metadata, of security events, past history of specific participants, a threat/security event provided by a threat exchange server, etc. to define or identify a security occurrence (e.g., a type or level of security threat to an entity). The security occurrence can be a parameter to rules and/or policies used to select particular granularity levels that are applied to information collection. For example, the policies can indicate that more detailed information (with specifics about which information and to what level) may be shared with the threat exchange if the security occurrence indicates a significant global security threat, but less may be shared if the security occurrence indicates that there is no significant security threat.

A granularity of the data can depend on the level of aggregation which, in turn, may be based on the time interval, (e.g., sum values of a particular measurement over a minute versus over an hour) or may be based on another attribute (e.g., values of a particular, measurement collected for an entire range of network addresses rather than reported individually).

Some of the values of these variables can be derived automatically and others manually input by the security administrator of the sharing organization. Global threat levels from the threat exchange server can be expressed as a general condition shared with all participants that can be automatically taken into account in what to share. When deciding the level of granularity of information about a security occurrence at a threat exchange participant, a security analyst can manually provide input such as the fact that a suspected threat is active in the organization. To address the dynamic and conditional nature of sharing these values, the external (or internal) parameters may carry an expiration date or expiration condition so that when the conditions that necessitated the higher level of monitoring are no longer present, the information collection level can go back to a default, or “normal” level either directly or in a graduated process, for example. In some examples, the threat exchange server can request higher information collection granularity from time to time to gather baseline information under normal conditions.

At 330, it is determined if a security occurrence is present and evidences a security context with an increased threat level. For example, the threat exchange server can determine if a global threat level has increased (e.g., affecting the threat exchange community or subgroup) or a particular participant has been targeted with an increased attacked (e.g., affecting the individual participant). If there is no increase in a threat posed by a security occurrence, the threat exchange server may decide to leave an information granularity collection level constant, or may decrease a granularity collection level. The granularity collection level can include a level of granularity at which the threat exchange server collects information from a participant or participants, for example.

If it is determined that the threat level is increased, an adequacy of the granularity of the information collected by the threat exchange server is determined at 331. This can be determined in compliance with a participant's information sharing policy, for example. For instance, if it is a participant's policy to never share information with a particular other participant in the threat exchange community, this will be considered when determining a granularity of information collected and/or requested.

If the threat exchange server determines there is sufficient granularity in the information it is collecting and has already collected, the threat exchange server may choose not to change an information granularity collection level. However, if it is determined the level is not adequate and more detailed information is needed from a participant or participants to address the security occurrence, it can select an increased information granularity collection level of a participant at 331. Information sensors within a participant and/or a threat exchange server can be reconfigured with the new level at 333.

Information at the determined granularity level is collected from participants at 334 by the threat exchange server and/or other participants within the community. Once the information is collected and utilized, it is determined at 335 whether the security occurrence has been contained. For example, a timeout is taken to determine a present threat level. if the threat level has decreased to an acceptable or “normal” level, the information sensors can be reconfigured at 336 to a default or “normal” granularity. In a number of examples, containing a security occurrence can include preventing the security occurrence from advancing (e.g., quarantining a security attack), eliminating the security occurrence (e.g., eliminating a security threat), and determining that the security occurrence was a false alarm (e.g., a suspected threat was harmless), among others.

Method 329 can allow for a threat exchange server to collect participant-provided information at an adequate level of detail for effective security occurrence detection, while reducing challenges (e.g., time consuming, expensive in time and labor, performance degradation, profiling by adversaries) to participants. In a number of embodiments of the present disclosure, the decision of the granularity of information collected and shared with a threat exchange server and other threat exchange community participants can depend on static properties of an environment and information type (e.g. network information and server logs are collected at different fixed frequencies), as well as a changing (e.g., dynamic) environment and context in which information is being shared. For example, when an overall threat level in the environment is increased or when a participant is facing a particular threat, a participant may be willing to collect and share information at a level of detail that it otherwise wouldn't. The threat exchange server can receive as much information as necessary to address particular security occurrence conditions without imposing a challenging, persistent collection burden on a participant or violating the confidentiality needs of the participant.

External parameters, such as a general threat level, may be the same for all (or at least subgroups) of the participants in the threat exchange community allowing for implementation of comparable sharing activities (e.g., comparable information granularity collection levels) among the participants. For example, in a high alert state, all participants may share sensitive information at a level of detail (e.g., every second) related to an incident that they normally would not because it may be critical to its resolution by the threat exchange community. Because highly detailed information is only shared infrequently and under abnormal circumstances, information that may fall into an adversary's hands may not be used to profile a participant's environment for the purpose of designing future attacks.

In another example, a participant within the threat exchange community may monitor file changes, and a threat exchange server can analyze these changes. Since file changes are frequent this can be very onerous for the participant. Even when the right information is collected, collecting it at the right granularity may be a challenge. For example, to capture the signature behavior or detect known malware it may be necessary to compute differences between files at very small intervals, perhaps seconds. This may cause moderate to severe CPU slowdown or storage overflow, as well as additional network bandwidth necessary to transmit the collected information. Since it may not be known ahead of time which files are important to track all files may be tracked, which may reveal information about what applications are installed on the participant's system. By varying the level of granularity (e.g., time interval) from seconds to hours or days, or by changing the filter that selects the files to track, these collateral problems may be mitigated so that increased levels of resource usage are only seen when the system is about to be attacked, so as to prevent those attacks.

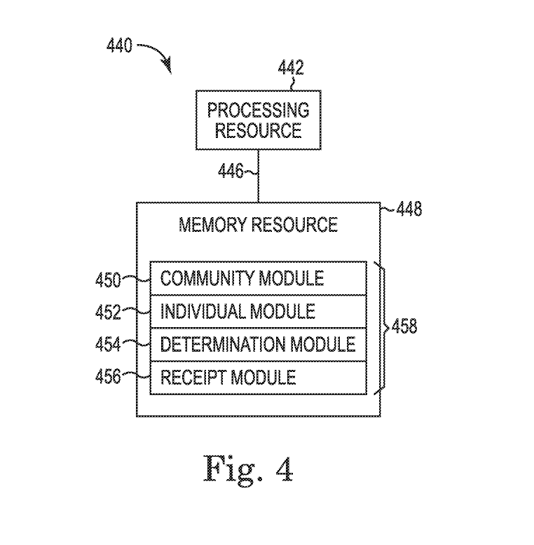

FIG. 4 illustrates a block diagram of an example of a system 440 according to the present disclosure. The system 440 can utilize software, hardware, firmware, and/or logic to perform a number of functions.

The system 440 can be any combination of hardware and program instructions configured to share information. The hardware, for example can include a processing resource 442, a memory resource 448, and/or computer-readable medium (CRM) (e.g., machine readable medium (MRM), database, etc.) A processing resource 442, as used herein, can include any number of processors capable of executing instructions stored by a memory resource 448. Processing resource 442 may be integrated in a single device or distributed across devices. The program instructions (e.g., computer-readable instructions (CRI)) can include instructions stored on the memory resource 448 and executable by the processing resource 442 to implement a desired function (e.g., sharing security context information).

The memory resource 448 can be in communication with a processing resource 442. A memory resource 448, as used herein, can include any number of memory components capable of storing instructions that can be executed by processing resource 442. Such memory resource 448 can be non-transitory CRM. Memory resource 448 may be integrated in a single device or distributed across devices. Further, memory resource 448 may be fully or partially integrated in the same device as processing resource 442 or it may be separate but accessible to that device and processing resource 442. Thus, it is noted that the system 440 may be implemented on a user and/or a participant device, on a server device and/or a collection of server devices, and/or on a combination of the user device and the server device and/or devices.

The processing resource 442 can be in communication with a memory resource 448 storing a set of CRI 458 executable by the processing resource 442, as described herein. The CRI 458 can also be stored in remote memory managed by a server and represent an installation package that can be downloaded, installed, and executed. The system 440 can include memory resource 448, and the processing resource 442 can be coupled to the memory resource 448.

Processing resource 442 can execute CRI 458 that can be stored on an internal or external memory resource 448. The processing resource 442 can execute CRI 458 to perform various functions, including the functions described with respect to FIGS. 1, 2, and 3. For example, the processing resource 442 can execute CRI 458 to share security context information such as information related to a security occurrence within a threat exchange community and suggest methods of mitigating security occurrences including threats.

The CRI 458 can include a number of modules 450, 452, 454, 456. The number of modules 450, 452, 454, 456, can include CRI 458 that when executed by the processing resource 442 can perform a number of functions. The number of modules 450, 452, 454, 456 can be sub-modules of other modules. For example, the community module 450 and the individual module 452 can be sub-modules and/or contained within the same computing device. In another example, the number of modules 450, 452, 454, 456 can comprise individual modules at separate and distinct locations (e.g., CRM etc.).

In some examples, the system can include a community module 450. A community module 450 can include CRI that when executed by the processing resource 442 can continuously identify community security occurrences associated with a threat exchange community based on a number of global parameters associated with the community. For example, a global security threat level can be continuously monitored, and the information used for monitoring can include global parameters such as, information regarding a threat affecting an entire threat exchange community and/or subgroups of the community.

An individual module 452 can include CRI that when executed by the processing resource 442 can continuously identify individual security occurrences for each of the number of participants based on a number of local parameters associated with each of the number of participants. For example, an individual local security threat level can be continuously monitored, and the information used for monitoring can include local parameters such as, for example, a particular participant's sharing history.

A determination module 454 can include CRI that when executed by the processing resources 442 can dynamically determine an amount and a granularity of participant-related information of each of the number of participants to share with at least one of a threat exchange server within the threat exchange community and the number of participants based on the community threats and each of the individual threats. For example how much information is shared, and at what granularity may vary based on security threat levels.

In a number of examples, determination module 454 can include CRI that when executed by the processing resources 442 can dynamically increase an amount of information and an information granularity level for each of the number of participants in response to a number of the community security occurrences including a security threat. Determination module 454 can include CRI that when executed by the processing resources 442 can dynamically decrease an amount of information and an information granularity level for each of the number of participants in response to the security threat subsiding.

In a number of embodiments, determination module 454 can include CRI that when executed by the processing resources 442 can dynamically increase an information granularity level for a first participant within the number of participants in response to an individual security occurrence associated with the first participant including a security threat and dynamically decrease an amount of information and an information granularity level for the first participant in response to the security threat subsiding.

A receipt module 456 can include CRI that when executed by the processing resource 442 can receive, via a communication link, the determined participant-related information at the at least one of the threat exchange server and the number of participants. For example, when it is determined what information is to be shared, a threat exchange server can be utilized to share information between participants and the server and/or between different participants within the threat exchange community. In some examples, after receiving participant-related information, threat mitigation suggestions can be shared between participants and a threat exchange server and/or between different participants within the threat exchange community.

A memory resource 448, as used herein, can include volatile and/or non-volatile memory. Volatile memory can include memory that depends upon power to store information, such as various types of dynamic random access memory (DRAM), among others. Non-volatile memory can include memory that does not depend upon power to store information.

The memory resource 448 can be integral, or communicatively coupled, to a computing device, in a wired and/or a wireless manner. For example, the memory resource 448 can be an internal memory, a portable memory, a portable disk, or a memory associated with another computing resource (e.g., enabling CRIs to be transferred and/or executed across a network such as the Internet).

The memory resource 448 can be in communication with the processing resource 442 via a communication link (e.g., path) 446. The communication link 446 can be local or remote to a machine (e.g., a computing device) associated with the processing resource 442. Examples of a local communication link 446 can include an electronic bus internal to a machine (e.g., a computing device) where the memory resource 448 is one of volatile, non-volatile, fixed, and/or removable storage medium in communication with the processing resource 442 via the electronic bus.

The communication link 446 can be such that the memory resource 448 is remote from the processing resource (e.g., 442), such as in a network connection between the memory resource 448 and the processing resource (e.g., 442). That is, the communication link 446 can be a network connection. Examples of such a network connection can include a local area network (LAN), wide area network (WAN), personal area network (PAN), and the Internet, among others. In such examples, the memory resource 448 can be associated with a first computing device and the processing resource 442 can be associated with a second computing device (e.g., a Java® server). For example, a processing resource 442 can be in communication with a memory resource 448, wherein the memory resource 448 includes a set of instructions and wherein the processing resource 442 is designed to carry out the set of instructions.

Ina number of examples, the processing resource 442 coupled to the memory resource 448 can execute CRI 458 to continuously identify, utilizing a threat exchange server, individual security occurrences affecting a participant within a threat exchange community and global security occurrences affecting the threat exchange community utilizing shared information tables. Individual security occurrences can include security occurrences specific to an individual participant in the threat exchange community. Examples can include information describing an individual participant's security context, security attacks, security threats, suspicious events, vulnerabilities, exploits, alerts, incidents, and/or other relevant events. Global security occurrences can include security occurrences specific to more than one participant in the threat exchange community. Examples can include information describing a global security context, security attacks, security threats, suspicious events, vulnerabilities, exploits, alerts, incidents, and/or other relevant events

The processing resource 442 coupled to the memory resource 448 can execute CRI 458 to dynamically request participant-related information from the first participant based on the individual security occurrences and the global security occurrences and in response to a change in at least one of the individual security occurrences and the global security occurrences, dynamically adjust a granularity of the participant-related information requested.

The processing resource 442 coupled to the memory resource 448 can execute CRI 458 to receive, at the threat exchange server, information associated with at least one of the individual security occurrences and the global security occurrences from the participant. In some instances, the processing resource 442 coupled to the memory resource 448 can execute CRI 458 to dynamically request participant-related information from a number of different participants within the threat exchange community, and to identify benign participant-related information shared by the first participant and instruct the first participant to stop sharing the benign information.

As used herein, “logic” is an alternative or additional processing resource to execute the actions and/or functions, etc., described herein, which includes hardware (e.g., various forms of transistor logic, application specific integrated circuits (ASICs), etc.), as opposed to computer executable instructions (e.g., software, firmware, etc.) stored in memory and executable by a processor.

The specification examples provide a description of the applications and use of the system and method of the present disclosure. Since many examples can be made without departing from the spirit and scope of the system and method of the present disclosure, this specification sets forth some of the many possible example configurations and implementations.

What is claimed:

1. A method for sharing information, the method comprising:
identifying, utilizing a threat exchange server, a security occurrence associated with a participant within a threat exchange community;
determining what participant-related information to share with the threat exchange server in response to the identified security occurrence; and
receiving, at the threat exchange server, information associated with the determined participant-related information via communication links within the threat exchange community.

2. The method of claim 1, wherein determining what participant-related information to share includes determining with what granularity to share the participant-related information with the threat exchange server.

3. The method of claim 1, wherein determining what participant-related information to share with the threat exchange server includes dynamically determining what participant-related information to share with the threat exchange server based on a number of security occurrences.

4. The method of claim 1, wherein identifying the security occurrence includes identifying the security occurrence utilizing information from global parameters and individual parameters.

5. The method of claim 4, wherein the information from global parameters and individual parameters includes an expiration date, and the information is deleted upon reaching the expiration date.

6. The method of claim 1, further including the threat exchange server suggesting a security occurrence mitigation strategy to the participant based on the security occurrence and the received information.

7. The method of claim 1, wherein the method is performed iteratively.

8. A non-transitory computer-readable medium storing a set of instructions executable by a processor to cause a computer to:
continuously identify, utilizing a threat exchange server, individual security occurrences affecting a participant within a threat exchange community and global security occurrences affecting the threat exchange community utilizing shared information tables;
dynamically request participant-related information from the participant based on the individual security occurrences and the global security occurrences;
in response to a change in at least one of the individual security occurrences and the global security occurrences, dynamically adjust a granularity of the participant-related information requested; and
receive, at the threat exchange server, information associated with at least one of the individual security occurrences and the global security occurrences from the participant.

9. The non-transitory computer-readable medium of claim 8, wherein the instructions executable by the processor to dynamically request participant-related information from the first participant include instructions executable by the processor to dynamically request participant-related information from a number of different participants within the threat exchange community.

10. The non-transitory computer-readable medium of claim 8, storing a set of instructions executable by the processor to identify benign participant-related information received at the threat exchange server and instruct the participant to stop sharing the benign information.

11. A system for sharing information, the system comprising a processing resource in communication with a non-transitory computer-readable medium, wherein the non-transitory computer-readable medium includes a set of instructions and wherein the processing resource is designed to carry out the set of instructions to:
continuously identify community security occurrences associated with a threat exchange community based on a number of global parameters associated with the community;
continuously identify individual security occurrences for each of the number of participants based on a number of local parameters associated with each of the number of participants;
dynamically determine an amount and a granularity of participant-related information of each of the number of participants to share with at least one of a threat exchange server within the threat exchange community and the number of participants based on the community security occurrences and each of the individual security occurrences; and
receive, via a communication link, the determined participant-related information at the at least one of the threat exchange server and the number of participants.

12. The system of claim 12, wherein the instructions to dynamically determine the amount and the granularity of participant-related information include instructions to dynamically increase an amount of information and an information granularity level for each of the number of participants in response to a number of the community security occurrences including a security threat.

13. The system of claim 12, wherein the instructions to dynamically determine the amount and the granularity of participant-related information include instructions to dynamically decrease an amount of information and an information granularity level for each of the number of participants in response to the security threat subsiding.

14. The system of claim 11, wherein the instructions to dynamically determine the amount and the granularity of participant-related information include instructions to dynamically increase an information granularity level for a first participant within the number of participants in response to an individual security occurrence associated with the first participant including a security threat.

15. The system of claim 14, wherein the instructions to dynamically determine the amount and the granularity of participant-related information include instructions to dynamically decrease an amount of information and an information granularity level for the first participant in response to the security threat subsiding.
